(19) United States
(12) Patent Application Publication
(10) Pub. No.: US 2022/0186346 A1
(43) Pub. Date: Jun. 16, 2022

(54) CR-RICH AL ALLOY WITH HIGH COMPRESSIVE AND SHEAR STRENGTH

(71) Applicant: Airbus Defence and Space GmbH, Taufkirchen (DE)

(72) Inventors: Frank PALM, Taufkirchen (DE); Marko BÄRTL, Taufkirchen (DE)

(21) Appl. No.: 17/560,633

(22) Filed: Dec. 23, 2021

Related U.S. Application Data
(63) Continuation of application No. PCT/EP2020/066039, filed on Jun. 10, 2020.

(30) Foreign Application Priority Data
Jun. 28, 2019 (DE) 10 2019 209 458.9

(51) Int. Cl. C22C 21/00; C22C 1/04; C22C 1/02; B33Y 70/00

(52) U.S. Cl. CPC C22C 21/00; C22C 1/0416; B22F 10/28; B33Y 70/00; C22C 1/026

(57) ABSTRACT

An Al alloy which contains Cr, to a component including an alloy of this type, to a method for producing the alloy and the component, and to a vehicle including a corresponding component.

### CROSS-REFERENCE TO RELATED APPLICATIONS

This application is a continuation of and claims priority to Patent Application No. PCT/EP2020/066039 filed Jun. 10, 2020, which claims priority to German Patent Application No. DE 10 2019 209 458.9 filed Jun. 28, 2019, the entire disclosures of which are incorporated by reference herein.

### TECHNICAL FIELD

The disclosure herein relates to a Cr-containing Al alloy, to a component comprising such an alloy, to processes for producing the alloy and the component, and to a vehicle comprising a corresponding component.

### BACKGROUND

The following material concepts are globally dominant nowadays in the field of laser powder bed melting (LPB-M) for Al materials:

a. AlSi & AlSiMg Alloys with Si Contents of 5-20 wt % and Mg Contents of 0.3-1.0 wt %

These alloys, after the LPB-M process, typically attain only a low yield point and also a low compressive yield point, and their energy absorption capacity (“crash performance”) is typically limited.

b. AlMgSc Alloys

The AlMgSc material concept Scalmalloy®, published, for example, in DE 10 2007 018123, attains good to very good strength values, typically by a special thermal aftertreatment. However, because the material characteristics depend on scandium, the main alloy element, it is fundamentally very expensive.

c. Further Al Alloys

Further Al material concepts that have been established for a short time are based, for example, on particles of reinforced or modified Al alloys, in the case of which TiB₂ (from Aermet, UK), Al₄C₃ (from Elementum3D, USA) or Zr-based nanoparticles (from Hughes Research Lab (HRL), USA) are mixed into the actual Al-base alloys. NanoAl (USA) have introduced an Al material concept which achieves an improvement in material indices by addition of relatively large amounts of rare earth (RE) metals, with toughness properties also remaining at a high level (e.g. elongation at break>15-20%). However, the RE metals here too incur high costs.

In the case of LPB-M, it is customary to use particular Al materials and then to produce the product material directly therefrom. As mentioned, the majority of these are binary or slightly modified AlSi materials (e.g. AlSi10Mg or AlSi12). A much firmer concept is that of AlMg alloys with additions of Sc (see Scalmalloy® patent). Compressive strength or tensile strength indices of up to 600 or 750 MPa are attained here. There is no knowledge or publication of further, even firmer Al alloys for LPB-M.

There is a need for Al alloys having improved compressive strength and compressive deformation properties.

### SUMMARY

According to the disclosure herein, this object is achieved by a Cr-containing aluminum alloy, a process for producing a component from a Cr-containing Al alloy, a component formed by the process, a component, a vehicle, a process for producing a Cr-containing Al alloy, and a process for producing a component comprising a Cr-containing Al alloy as disclosed herein.

In the course of LPB-M development campaigns to create new Al material concepts, the inventors have observed that AlCr alloys show unusual compressive strength characteristics. More particularly, it has been found that, for AlCr alloys, especially with additions of Mn and Zr, compressive strength and compressive deformation values are well above (>25%) those of AlMgSc alloys and more than twice as high (>50%) as for the established AlSi(Mg) alloys. Consequently, a Cr-containing Al alloy of the disclosure herein is especially suitable for newly established Al material concepts for pressure-, stability- and/or crash-stressed structures and components, especially based on LPB-M manufacture.

Advantageous configurations and developments are apparent from the description with reference to the figures.

### BRIEF DESCRIPTION OF THE DRAWINGS

The disclosure herein is elucidated in detail hereinafter by the working examples given in the schematic figures.

FIG. 1 shows a schematic of a process of the disclosure herein for producing a component.

FIG. 2 shows a schematic of one embodiment of the process for producing a component.

FIG. 3 additionally shows a schematic of a process of the disclosure herein for producing a Cr-containing Al alloy.

FIG. 4 shows results of compression tests in examples of the disclosure herein.

### DETAILED DESCRIPTION

The appended figures are intended to impart further understanding of the embodiments. They illustrate embodiments and, in association with the description, serve to elucidate principles and concepts of the disclosure herein. Other embodiments and many of the advantages mentioned are apparent with regard to the drawings. The elements of the drawings are not necessarily shown true to scale relative to one another.

In the figures of the drawing, elements, features and components that are the same, have the same function and the same effect—unless stated otherwise—are each given the same reference numerals.

### Definitions

Unless defined differently, technical and scientific expressions used herein have the same meaning as commonly understood by a person skilled in the art in the field of the disclosure herein.

A component in the context of the disclosure herein is not particularly restricted and may especially be any piece or part that may be manufactured for a structure, an aggregate, a machine, etc.

A shaped article is a formed part which is formed by a forming process.

The lanthanoids include the elements La, Ce, Pr, Nd, Pm, Sm, Eu, Gd, Tb, Dy, Ho, Er, Tm, Yb, and Lu.

Amounts in the context of the disclosure herein relate to wt %, unless stated otherwise or apparent from the context. In the context of the disclosure herein, the percentages by weight in an alloy, a component, etc. add up to 100 wt %, unless stated otherwise or apparent from the context.

In a first aspect, the disclosure herein relates to a Cr-containing Al alloy consisting of:

0.5-20.0 wt %, preferably 1.0-10.0 wt %, further preferably 2.0-8.0 wt %, especially preferably 4.0-6.0 wt %, of Cr;

0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present;

0.0-6.0 wt %, preferably 0.3-5.0 wt %, further preferably 0.5-3.0 wt %, especially preferably 0.7-2.0 wt %, of at least one element selected from the group consisting of Sc, Y and the lanthanoids;

0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn and Pb;

and as the balance Al and unavoidable impurities, where the percentages by weight add up to 100 wt % in the Cr-containing Al alloy.

The Cr-containing Al alloy is notable for a relatively high chromium content of 0.5-20.0 wt %, preferably 1.0-10.0 wt %, further preferably 2.0-8.0 wt %, even further preferably 3.5-7 wt %, especially preferably 4.0-6.0 wt %, of Cr. In particular embodiments, an alloy of the disclosure herein is based on an AlCr5 alloy (with 5 wt % of Cr).

In addition, the Cr-containing Al alloy of the disclosure herein contains 0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co, and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present.

The Cr-containing Al alloy may thus, for example based on an AlCr-base alloy, contain up to 3 transition metals of main groups 4-10 of the Periodic Table of the Elements (PTE), excluding the group of precious metals or refractory precious metals (main groups 7-10/periods 5-6). Correspondingly, it is also possible for mixtures of up to 3 elements selected from the group consisting of Ti, Zr, Hf, V, Nb, Ta, Mo, W, Mn, Fe, Co, and Ni to be present in the alloy.

The stated amount of 0.0-6.0 wt %, preferably 0.3-5.0 wt %, further preferably 0.8-3.0 wt %, especially preferably 1.0-2.0 wt %, of the at least one element selected from the group consisting of Ti, Zr, Hf, V, Nb, Ta, Mo, W, Mn, Fe, Co, and Ni is based here in each case on the amount of a single one of the elements in wt %. Thus, if 2 of the elements mentioned are present, the Cr-containing Al alloy of the disclosure herein may contain 0.0-12.0 wt %, preferably 0.6-10.0 wt %, further preferably 1.6 to 6.0 wt %, especially preferably 2.0-4.0 wt %, of the two elements mentioned in total, and, when 3 of the elements mentioned are present, the Cr-containing Al alloy may contain 0.0-18.0 wt %, preferably 0.9-15.0 wt %, further preferably 2.4 to 9.0 wt %, especially preferably 3.0-6.0 wt %, of the three elements mentioned in total, where each element is present in an amount of 0.0-6.0 wt %, preferably 0.3-5.0 wt %, further preferably 0.8-3.0 wt %, especially preferably 1.0-2.0 wt %.

While it is not ruled out that none of the elements of Ti, Zr, Hf, V, Nb, Ta, Mo, W, Mn, Fe, Co, and Ni is present in the alloy, in particular embodiments, at least Mn and/or Zr is present. In particular embodiments, Mn and Zr are present.

In addition, the Cr-containing Al alloy of the disclosure herein may contain 0.0-6.0 wt %, for example 0.1-5.5 wt %, preferably 0.3-5.0 wt %, preferably 0.5-3.0 wt %, more preferably 0.7-2.0 wt %, of at least one element selected from the group consisting of Sc, Y, and the lanthanoids. It is thus not ruled out that none of the elements selected from the group consisting of Sc, Y, and the lanthanoids is present. It is also possible for mixtures of elements selected from the group consisting of Sc, Y, and the lanthanoids to be present in the alloy. In particular embodiments, the Cr-containing Al alloy of the disclosure herein contains 0.0-6.0 wt %, preferably 0.3-5.0 wt %, further preferably 0.5-3.0 wt %, especially preferably 0.7-2.0 wt %, of up to 3 elements from the third main group including the extension thereof to the group of lanthanoids (rare earth metals (RE)). Correspondingly, it is then possible, in the case of 2 elements selected from the group consisting of Sc, Y, and the lanthanoids, for a total of 0.0-12.0 wt %, for example 0.2-11 wt %, preferably 0.6-10.0 wt %, further preferably 1.0-6.0 wt %, especially preferably 1.4-4.0 wt %, of the two elements to be present, and, when 3 elements selected from the group consisting of Sc, Y, and the lanthanoids are present, it is possible for a total of 0.0-18 wt %, for example 0.3-16.5 wt %, preferably 0.9-15.0 wt %, further preferably 1.5-9.0 wt %, especially preferably 2.1-6.0 wt %, to be present, where each element is present in an amount of 0.0-6.0 wt %, for example 0.1-5.5 wt %, preferably 0.3-5.0 wt %, further preferably 0.5-3.0 wt %, especially preferably 0.7-2.0 wt %. In particular embodiments, the amount of the sum total of the elements selected from the group consisting of Sc, Y, and the lanthanoids is within a range of 0.0-6.0 wt %, for example 0.1-5.5 wt %, preferably 0.3-5.0 wt %, further preferably 0.5-3.0 wt %, especially preferably 0.7-2.0 wt %.

In addition, the alloy of the disclosure herein contains 0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn, and Pb. It is thus not ruled out that none of the elements selected from the group consisting of B, Ga, In, C, Si, Ge, Sn, and Pb is present. It is also possible for mixtures of elements selected from the group consisting of B, Ga, In, C, Si, Ge, Sn, and Pb to be present in the alloy. In particular embodiments, the amount of the sum total of the elements selected from the group consisting of B, Ga, In, C, Si, Ge, Sn, and Pb is within a range of 0.0-2.5 wt %, preferably 0.2-2.0 wt %, further preferably 0.4-1.5 wt %, especially preferably 0.6-1.0 wt %.

As the balance, the Cr-containing Al alloy of the disclosure herein contains Al and unavoidable impurities, where the percentages by weight add up to 100 wt % in the Cr-containing Al alloy.

In particular embodiments, the microstructure of the Cr-containing Al alloy has been optimized by a thermal aftertreatment.

For example, a Cr-containing Al alloy of the disclosure herein produced directly, for example by laser powder bed melting (LPB-M), by skillful heat control during the production process or after the end of the LPB-M by a separate thermal aftertreatment, can be optimized and improved in terms of its microstructure, for example with regard to grain size, segregation (by separation), primary solidified phases, secondary precipitates formed by interdiffusion processes, etc., and also with regard to the remaining solidification-related intrinsic stresses, in order that strength and toughness are in a good ratio relative to one another. For instance, a Cr-containing Al alloy of the disclosure herein may especially have a compression yield point of >400 MPa, especially >450 MPa, and/or a compression set of >8%, especially >10%, measured to DIN 50106, 2016-11.

In particular embodiments, the Cr-containing Al alloy of the disclosure herein is subjected to a thermal aftertreatment. A suitable thermal aftertreatment may be effected here in one or more stages.

A suitable thermal aftertreatment may proceed, for example, as follows: in particular embodiments, a (first) thermal aftertreatment step is conducted within a temperature window of 150-500° C., preferably 250-450° C., and/or with a treatment time of 15 min-3000 min, preferably 120-240 min. In particular embodiments, it is also possible here for the temperature to be varied in one or more stages, e.g. 250° C. followed by 400° C. or else, conversely, 400° C. followed by 250° C., where the stages here are not particularly restricted.

In particular embodiments, the process of thermal aftertreatment may be conducted partly or wholly under pressure, especially pressure from all sides.

In particular embodiments, after a first thermal aftertreatment step as specified above (in an (overall) thermal process), there may be a quench, for example in water or the like, especially to less than 60° C., preferably to 40° C. or less or even room temperature (e.g. about 25° C.) or less, or an interruption (with a corresponding shortening of the time in the first heat treatment, for example to 5 to 1500 min) or a stoppage of the heat treatment by a gas, for example a gas which is inert toward the alloy, such as hydrogen, nitrogen, and/or at least one noble gas, especially at least one non-reactive gas such as a noble gas or the like, preferably with a cooling rate of at least 50 K/min, preferably at least 75 K/min, further preferably 100 K/min or more. In particular embodiments, after a quench or interruption, a second thermal treatment step may be conducted within a temperature window of 150-500° C., preferably 250-400° C., and/or with a treatment time of 15 min-3000 min, preferably 120-240 min. In particular embodiments, it is also possible here to vary the temperature in one or more stages, for example 250° C. followed by 400° C. or else, conversely, 400° C. followed by 250° C., where the stages here are not particularly restricted.

It is also not ruled out that further steps of quenching or interruption and/or further thermal treatment steps are conducted.

In a further aspect, the disclosure herein relates to a process for producing a component, especially shaped article, from a Cr-containing Al alloy, comprising
forming a Cr-containing Al alloy consisting of:

0.5-20.0 wt %, preferably 1.0-10.0 wt %, further preferably 2.0-8.0 wt %, especially preferably 4.0-6.0 wt %, of Cr;

0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present;

0.0-6.0 wt %, preferably 0.3-5.0 wt %, further preferably 0.5-3.0 wt %, especially preferably 0.7-2.0 wt %, of at least one element selected from the group consisting of Sc, Y and the lanthanoids;

0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn, Pb;

and as the balance Al and unavoidable impurities, where the percentages by weight add up to 100 wt % in the Cr-containing Al alloy, and
forming the component, especially shaped article.

It is not ruled out in accordance with the disclosure herein that the forming of the Cr-containing Al alloy also at least partly or completely already forms the component, as for instance in an additive manufacturing method. In particular embodiments, at least the forming of the component is effected by additive manufacturing, for example powder bed melting or melting with a focused energy source, especially laser powder bed melting (LPB-M), or more specifically metallic laser powder bed melting (LPB-M). This manufacturing method enables the direct production of components, especially 3D components, from CAD data. It is a particular feature of this method that very rapid cooling conditions can be achieved and, as a result thereof, particular Al material-based alloy concepts become implementable that were typically not producible with the desired profile of properties in the case of established (slower) cooling conditions.

The forming of a Cr-containing Al alloy here is not particularly restricted. More particularly, a Cr-containing Al alloy of the first aspect of the disclosure herein is formed. Correspondingly, the details relating to the Cr-containing Al alloy of the first aspect also relate to the process for producing a component, especially shaped article, from a Cr-containing Al alloy.

In particular embodiments, the forming of the Cr-containing Al alloy comprises providing and mixing of powders of the elements present in the Cr-containing Al alloy in the weights required for the Cr-containing Al alloy, and at least partial melting of the powders.

The providing and mixing of powders of the elements present in the Cr-containing Al alloy in the weights required for the Cr-containing Al alloy is not particularly restricted in accordance with the disclosure herein, as long as the powders are provided in weights such that, on mixing, the proportions by weight correspond essentially and especially correspond to the weights in the final Cr-containing Al alloy. For example, the powders may be weighed out and mixed in accordance with the desired amounts.

In particular embodiments, the forming of the Cr-containing Al alloy comprises providing and mixing of prealloy materials and/or metal of the elements present in the Cr-containing Al alloy, in the weights required for the Cr-containing Al alloy, and at least partial melting of the powders. For example, it is possible here to mix Al with suitable prealloy materials, for example prealloys of Al and Cr and further prealloys, for example of Al and Mn and/or Al and Zr. After the melting, it is then possible here, for example, to form the Cr-containing Al alloy of the disclosure herein, for example even in powder form after spraying.

The at least partial melting of the powders is likewise not particularly restricted.

In particular embodiments, the melting is effected by at least one laser and/or a corresponding focusable energy source, wherein the component, especially shaped article, is preferably produced by laser powder bed melting (LPB-M). The laser powder bed melting and the laser used are not particularly restricted here. For the powder bed melting, rather than a laser energy source, it is also possible to use a different focusable energy source (e.g. electron beam or plasma jet).

However, the forming of the component, especially shaped article, is not particularly restricted in accordance with the disclosure herein and can also be effected in a different way than LPB-M, provided that the Cr-containing Al alloy has been formed beforehand. For example, it is also possible that the component is formed using prealloyed powders, meaning that the alloy is first formed in powder form. But it would also be possible to appropriately mix elemental powders and then to create the alloy chemistry in situ during the melting, for example when a laser-powder-nozzle concept is utilized, in which case the powder is sprayed onto a substrate and melted by a coaxial laser beam. In that case, it is also possible here, for example, to gradually alter the powder composition, by which it is possible to form components with different alloy ranges, meaning ranges with different alloy composition. It is also possible to add alloy elements optionally as elemental powders, or it is possible to create a master melt which is then jetted separately to form powders, which may then be remelted in turn by LPB-M, for example to a corresponding component geometry or parts thereof.

It would also be possible here to form components comprising an alloy of the disclosure herein only in part. Accordingly also disclosed is a process for producing a component, especially shaped article, comprising a Cr-containing Al alloy, comprising:
forming a Cr-containing Al alloy consisting of:

0.5-20.0 wt %, preferably 1.0-10.0 wt %, further preferably 2.0-8.0 wt %, especially preferably 4.0-6.0 wt %, of Cr;

0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present;

0.0-6.0 wt %, preferably 0.3-5.0 wt %, further preferably 0.5-3.0 wt %, especially preferably 0.7-2.0 wt %, of at least one element selected from the group consisting of Sc, Y and the lanthanoids;

0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn, Pb;

and as the balance Al and unavoidable impurities, where the percentages by weight add up to 100 wt % in the Cr-containing Al alloy, and
forming the component, especially shaped article, comprising the Cr-containing Al alloy.

Such a process would also be implemented if, for example, additive manufacturing onto a substrate is effected, but the constituent of the component does not consist of a Cr-containing Al alloy of the disclosure herein.

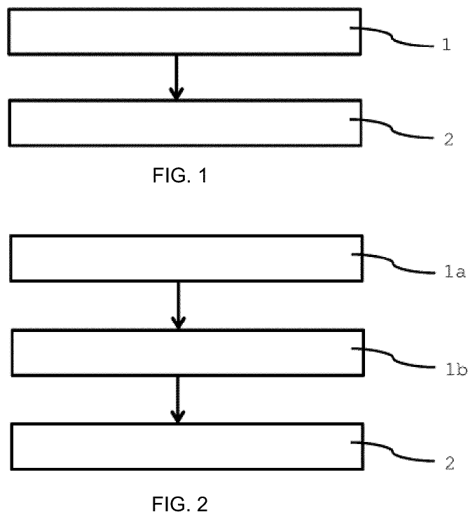

Illustrative processes of the disclosure herein for production of a component from a Cr-containing Al alloy are shown in FIGS. 1 and 2.

According to FIG. 1, in this case, the Cr-containing Al alloy is formed in step 1, and the component, especially shaped article, is formed in step 2. In the process of FIG. 2, in this case, step 1 of FIG. 1 is divided into a step 1a of providing and mixing powders or prealloy materials and/or metal of the elements present in the Cr-containing Al alloy, and a step 1b of at least partly melting the powder or prealloy materials and/or metals.

For the melting, it is possible, for example, to produce AlCr powders by inert gas atomization. It is optionally possible to add the further alloy elements such as Mn and/or Zr, but also other defined transition metals, semiconductor metals and/or rare earth metals, to the alloy. Corresponding powders may then be melted layer by layer, for example following CAD data, for example in an LPB-M system, so as to form a component, e.g. 3D component. Since, in a corresponding LPB-M system, the forming of the alloy and the component, i.e. component and component material production, can be effected simultaneously in one process, it is also possible in particular embodiments to effect an appropriate thermal aftertreatment, for example low-stress annealing. This can be effected in an apparatus for production of the component or separately, for example in an oven or the like.

In particular embodiments, during the forming of the component, a further thermal treatment improves the microstructure of the component.

In particular embodiments, the Cr-containing Al alloy of the disclosure herein or the component, especially shaped article, is subjected to a thermal aftertreatment, for example during the forming of the component. A suitable thermal aftertreatment here may have one or more stages.

A suitable thermal aftertreatment may proceed, for example, as follows: in particular embodiments, a (first) thermal aftertreatment step is conducted within a temperature window of 150-500° C., preferably 250-450° C., and/or with a treatment time of 15 min-3000 min, preferably 120-240 min. In particular embodiments, it is also possible here for the temperature to be varied in one or more stages, e.g. 250° C. followed by 400° C. or else, conversely, 400° C. followed by 250° C., where the stages here are not particularly restricted.

In particular embodiments, the process of thermal aftertreatment may be conducted partly or wholly under pressure, especially pressure from all sides.

In particular embodiments, after a first thermal aftertreatment step as specified above (in an (overall) thermal process), there may be a quench, for example in water or the like, or an interruption or a stoppage of the heat treatment by a gas, especially a non-reactive gas such as a noble gas or the like. In particular embodiments, after a quench or interruption, a second thermal treatment step may be conducted within a temperature window of 150-500° C., preferably 250-450° C., and/or with a treatment time of 15 min-3000 min, preferably 120-240 min. In particular embodiments, it is also possible here to vary the temperature in one or more stages, for example 250° C. followed by 400° C. or else, conversely, 400° C. followed by 250° C., where the stages here are not particularly restricted.

It is also not ruled out that further steps of quenching or interruption and/or further thermal treatment steps are conducted.

In particular embodiments, in the forming of the component, especially shaped article, a pressure of 260-6700 bar, preferably 500-5000 bar, further preferably 1000-2000 bar, is employed, where the pressure is especially preferably applied by at least one gas and/or at least one liquid. In principle, however, purely mechanical compression is also possible, for example with the aid of a die.

Such application of pressure or pressurization can also be effected, for example, during a thermal aftertreatment. In particular embodiments, the application of pressure or pressurization is effected during a thermal aftertreatment. This can additionally improve the microstructure of the alloy in the component. For example, the component can be recompacted by hot isostatic pressing (HIP).

The gas and/or liquid for the application of pressure are not particularly restricted, with the gas and/or liquid typically being selected such that it is inert with respect to the material of the component, noting the process temperature. In the case of gas, for example, argon or nitrogen will always work. Liquids used may, for example, be water or water-polymer mixtures up to about 250° C., but there are also what are called thermal oils (silicone-based). Beyond 450° C. it is possible, for example, to use molten salts. Examples of suitable gases include noble gases and mixtures thereof.

In particular embodiments, external pressure is applied locally in the forming of the component, especially shaped article. The local application of pressure is not particularly restricted here, and can be effected, for example, by shot blasting or laser shock peening, etc. Resultant superficial intrinsic compressive stresses can improve the fatigue performance and fatigue failure performance of the AlCr alloy.

The disclosure herein additionally relates to a component, especially shaped article, that is formed by the process for forming the component, especially shaped article.

Additionally disclosed is a component, especially shaped article, comprising a Cr-containing Al alloy, consisting of:

0.5-20.0 wt %, preferably 1.0-10.0 wt %, further preferably 2.0-8.0 wt %, especially preferably 4.0-6.0 wt %, of Cr;

0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present;

0.0-6.0 wt %, preferably 0.3-5.0 wt %, further preferably 0.5-3.0 wt %, especially preferably 0.7-2.0 wt %, of at least one element selected from the group consisting of Sc, Y and the lanthanoids;

0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn, Pb;

and as the balance Al and unavoidable impurities, where the percentages by weight add up to 100 wt % in the Cr-containing Al alloy.

The shaped article is especially produced by the process of the disclosure herein or using the Cr-containing Al alloy of the disclosure herein. Accordingly, the above details relating to the alloy of the disclosure herein and relating to the process of the disclosure herein for producing a component also relate to the component itself.

Furthermore, the component is not particularly restricted and may be a shaped article, part of a larger structure, for instance of a support structure, etc.

In particular embodiments, the component, especially shaped article, is a component of a vehicle, especially aircraft or spacecraft, or part thereof.

For example, the component may be three-dimensional, for example in the form of a 3-dimensionally configured fitting of complex shape or of a strut or of a force distributor node, where compressive and shear forces often also act in addition to tensile stresses in such components, or these elements are part of a construction that is to absorb a particularly large amount of energy in a crash situation, for example by virtue of high compressive strength and deformation. Correspondingly, such components are also not limited to the field of aerospace, but are also suitable in principle for automotive and/or rail vehicle applications.

A further aspect of the disclosure herein relates to a vehicle, especially aircraft or spacecraft, comprising a component of the disclosure herein, especially shaped article. Possible vehicles thus include not only aircraft, rockets, satellites, helicopters, etc. from the aerospace sector, but also vehicles from the automotive and rail sector, such as cars, motorbikes, trains, etc.

Additionally disclosed is a process for producing a Cr-containing Al alloy, consisting of:

0.5-20.0 wt %, preferably 1.0-10.0 wt %, further preferably 2.0-8.0 wt %, especially preferably 4.0-6.0 wt %, of Cr;

0.0-6.0 wt %, preferably 0.3-5.0 wt %, further preferably 0.8-3.0 wt %, especially preferably 1.0-2.0 wt %, of at least one element selected from the group consisting of Ti, Zr, Hf, V, Nb, Ta, Mo, W, Mn, Fe, Co and Ni, especially Zr and/or Mn, where up to 3 elements selected from the group consisting of Ti, Zr, Hf, V, Nb, Ta, Mo, W, Mn, Fe, Co, Ni, especially Zr and/or Mn, are present;

0.0-6.0 wt %, preferably 0.3-5.0 wt %, further preferably 0.5-3.0 wt %, especially preferably 0.7-2.0 wt %, of at least one element selected from the group consisting of Sc, Y and the lanthanoids;

0.0-2.5 wt %, preferably 0.2-2.0 wt %, further preferably 0.4-1.5 wt %, especially preferably 0.6-1.0 wt %, of at least one element selected from the group consisting of B, Ga, In, C, Si, Ge, Sn, Pb;

and as the balance Al and unavoidable impurities, where the percentages by weight add up to 100 wt % in the Cr-containing Al alloy, comprising:
providing and mixing the elements present in the Cr-containing Al alloy in the weights required for the Cr-containing Al alloy, especially as powder or as prealloy materials and metal,
melting the elements, especially as powder or as prealloy materials and metal, and
forming the Cr-containing Al alloy.

More particularly, it is possible by this process to produce an alloy of the disclosure herein, and so the details relating to the Cr-containing Al alloy of the first aspect also relate to the process for producing the alloy. The steps used here may also correspond to the corresponding steps in the process of the disclosure herein for producing a component.

The providing and mixing of the elements present in the Cr-containing Al alloy in the weights required for the Cr-containing Al alloy, especially as powders and/or prealloy materials, the melting of the elements, especially the powders, and the forming of the Cr-containing Al alloy are not particularly restricted here.

The providing and mixing of the elements present in the Cr-containing Al alloy in the weights required for the Cr-containing Al alloy is not particularly restricted in accordance with the disclosure herein, as long as the elements are provided in weights such that, on mixing, the proportions by weight correspond essentially and especially correspond to the weights in the final Cr-containing Al alloy. For example, the elements may be weighed out and mixed in powder form in accordance with the amounts desired, or it is possible to suitably weigh out and mix prealloy materials and metal, e.g. Al and aluminum prealloys such as AlCr10, AlMn10, AlZr10 as master alloys.

In particular embodiments, the forming of the Cr-containing Al alloy comprises providing and mixing prealloy materials and/or metal of the elements present in the Cr-containing Al alloy in the weights required for the Cr-containing Al alloy, and at least partly melting the powders. For example, it is possible here to mix Al with suitable prealloy materials, for example prealloys of Al and Cr and further prealloys, for example of Al and Mn and/or Al and Zr. After the melting, it is then possible here, for example, to form the Cr-containing Al alloy of the disclosure herein, for example even in powder form after spraying.

Melting of the elements, especially of powders, is likewise not particularly restricted and can be effected in any manner, for example by heating in an oven, crucible, etc., by introducing focused energy, etc.

In particular embodiments, the melting is effected by at least one laser and/or a corresponding focusable energy source, for example in a powder bed, e.g. laser powder bed melting (LPB-M). Laser powder bed melting and the laser used are not particularly restricted here. For powder bed melting, rather than a laser energy source, it is also possible to use another focusable energy source (e.g. electron beam or plasma jet).

According to the disclosure herein, the forming of the Cr-containing Al alloy is not particularly restricted and can be effected, for example, directly in the melt or include a solidification. It would also be possible to appropriately mix elemental powders and then to create the alloy chemistry in situ during the melting. It is also possible to add alloy elements optionally as elemental powders, or it is possible to create a master melt which is then jetted separately to form alloy powders.

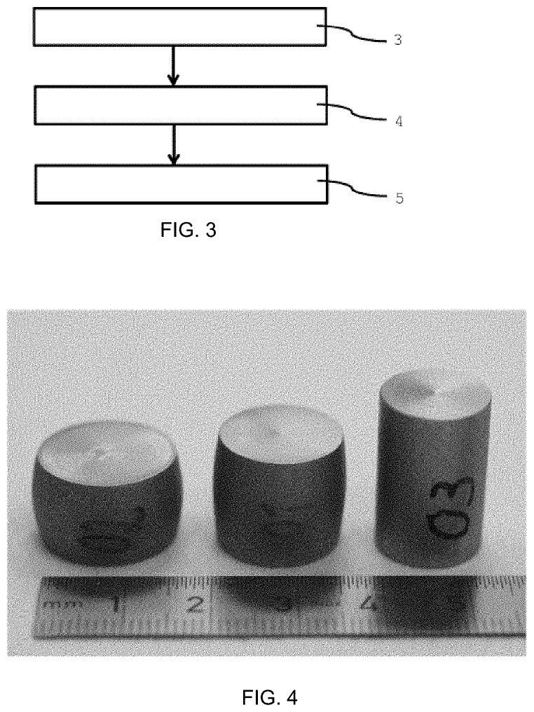

An illustrative process of the disclosure herein for producing a Cr-containing Al alloy is shown in schematic form in FIG. 3. In this case, step 3 of providing and mixing the elements present in the Cr-containing Al alloy, for example in the form of Al metal and prealloy materials, in the weights required for the Cr-containing Al alloy, is followed by a step 4 of melting the elements and a step 5 of forming the Cr-containing Al alloy.

The above configurations and developments can be combined with one another as desired where viable. Further possible configurations, developments and implementations of the disclosure herein also include combinations that are not specified explicitly of features of the disclosure herein that have been described above or are described hereinafter with regard to the working examples. In particular, the person skilled in the art will also add on individual aspects as improvements or additions to the respective basic form of the disclosure herein.

The disclosure herein is elucidated further in detail hereinafter with reference to various examples. However, the disclosure herein is not restricted to these examples.

### EXAMPLES

### Example 1: Producing an AlCrMnZr Alloy from Prealloy Compositions or Elemental Powders

Metal powders or prealloy compositions are used to produce a Cr-containing Al alloy, by first mixing elemental powders or prealloy materials (e.g. Al and aluminum prealloys such as AlCr10, AlMn10, AIZr10 as master alloys) in such a way as to result in a material having the following composition:

Cr 4.8 wt %, Zr 1.4 wt %, Mn 1.4 wt %, balance: Al and unavoidable impurities.

The material was melted and used to produce an alloy powder by jetting.

### Example 2: Component Production and Component Material Creation by LPB-M

The components were produced in a laser powder bed melting system (SLM125 HL) with the AlCrMnZr material. The compressive strength of the components was checked by compression tests that are discussed in more detail below.

First of all, the component to be printed in the laser powder bed melting system is constructed in the form of a CAD model. This CAD model is saved in stl file format, which defines the component surface by triangles. Subsequently, with the aid of slicing software called Magics, the component to be printed, a cylinder for pressure tests, is aligned in the virtual built space of the laser melting system and optionally provided with support structure. The slicing involves cutting the component virtually into several hundreds to thousands of slices. This depends on the component size and layer thickness. In addition, in Magics, appropriate parameters required for the printing (laser melting/laser generation/additive manufacturing) are assigned to the component. More particularly, the following parameters were fixed:

| | |
|---|---|
| Power in W | 350 |
| Scan rate in mm/s | 1500 |
| Hatch (separation of the laser tracks) in mm | 0.11 |
| Layer thickness in mm | 0.03 |
| Exposure strategy | strip hatching |
| Velocity of the gas stream (Ar) vgas in % 65 | |
| Focus position in mm | 0 (at the focus) |
| Platform temperature in ° C. | room temperature |
| | (about 25° C.) |

Once the parameters had been assigned, the file was saved in slm file format and sent to the system.

For printing, in addition, the alloy powder was subjected to powder preparation. The powder (alloy) is dried in the air circulation oven at 80° C. for 3 h and then introduced into a corresponding plastic vessel/reservoir vessel, which are then mounted on the laser melting system.

In addition, the laser melting system is fitted and made ready. The build plate mounted in the build chamber of the system is a plate consisting of AlSi10Mg. After the coater of the system has been filled with the alloy powder, the build chamber of the system is flooded with protective gas. This involves first purging the build chamber with argon (protective gas) until the oxygen content in the build chamber is <500 ppm.

Thereafter, the production of the component, i.e. the “build job”, can be started. This involves closing a magnetic valve of the system and setting a constant inert gas flow just above the build plate in the build chamber. The alloy powder is deposited on the build plate by the coater and the laser is used to generate the first layer of the component. Thereafter, the build plate is lowered by 0.03 mm (layer thickness), the coater again deposits powder a, b, and the laser melts a second component layer and automatically welds it to the layer beneath.

Once these process steps have been conducted repeatedly and the component has been fully generated, the component can be removed from the system. For this purpose, first of all, the build plate including the generated component is moved upward in z direction, such that excess powder can be removed. The build plate can then be detached and the build plate can be removed.

Thereafter, the components (printed samples) are sawn off the build plate by a bandsaw. The printed samples are then turned planar (machined) by removal of material to a corresponding degree on either side according to DIN 50106, 2016-11 (also referred to as DIN 50106 for short in the description). This should take account of the height:diameter ratio of the printed samples of 1≤h₀/d₀≤2 (h₀: base height, d₀: base diameter, here 10 mm) according to DIN 50106. The outer surface remains in the “as-built” state. This means that the outer surface of the printed sample was not treated or processed to remove material.

First of all, tensile tests were conducted to DIN 50125, 2016-12 (also referred to as DIN 50125 for short in the description), in order to determine tensile strength, elongation at break and constriction at break. Thereafter, a compression test to DIN 50106 is conducted. This involves placing an extensometer directly onto the printed sample.

Since the mechanical properties of the alloy with regard to tensile strength (tensile specimens according to DIN 51025) were very good, and elongation at break and constriction at break were very low, which suggests a brittle, low-deformation material, it was assumed that the printed sample would shatter into countless individual pieces even under low stress.

Once the compression test had been started and the die had been pressed onto the printed sample with increasing force, it was found that the sample does not shatter as expected, but deforms plastically and without formation of cracks. Astonishingly, the printed sample withstood a compressive stress R_{dm} (maximum compressive stress) of 1010 MPa without cracking and without shattering; see FIG. 4. A test force of 150 kN (about 15 t) was applied here to the sample, as shown on the left in FIG. 4. For comparison, two further printed samples are shown in FIG. 4, with a printed sample from a terminated experiment shown in the middle, in which the test machine was not able to apply sufficient test force, and a printed sample in the original state shown on the right.

It was not possible to determine the compressive strength R_{db} (compressive strength at break) since this is determined by definition only in the case of “sample fracture into two (or more) parts”. The compression test had to be stopped owing to the high forces (about 15 t), since there was a risk that the test system could possibly be damaged (on account of extremely high forces). The yield point R_{do0.2} was 359 MPa. It was not possible to find comparably high values in the literature.

As the studies in accordance with the disclosure herein have additionally shown, it is possible via appropriate selection of the thermal aftertreatment temperature and thermal aftertreatment time to manipulate the cast material microstructure of the AlCrMnZr alloy created directly in the powder bed in a controlled manner. For instance, by a heat treatment under air at 400° C. for 2 h, it is possible to improve tensile and compressive strength since forcibly dissolved chromium now undergoes secondary precipitation as Al₄Cr & Al₂Cr phase. This astonishingly also improves the toughness of the ACrMnZr material, since the relatively high thermal treatment temperature manipulates the size and distribution in a positive manner, and additionally the interfacial chemistry (coherence) of these two phases with respect to the Al matrix.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

1 Forming of the Cr-containing Al alloy
1a Providing and mixing of powders of the elements present in the Cr-containing Al alloy
1b At least partial melting of the powder
2 Forming of the component, especially shaped article
3 Providing and mixing of the elements present in the Cr-containing Al alloy
4 Melting of the elements
5 Forming of the Cr-containing Al alloy

1. A Cr-containing Al alloy consisting of:
0.5-20.0 wt %, or 1.0-10.0 wt %, or 2.0-8.0 wt %, or 4.0-6.0 wt %, of Cr;
0.0-6.0 wt %, or 0.3-5.0 wt %, or 0.8-3.0 wt %, or 1.0-2.0 wt %, of at least one element selected from the group consisting of Ti, Zr, Hf, V, Nb, Ta, Mo, W, Mn, Fe, Co and Ni, where up to 3 elements selected from the group consisting of Ti, Zr, Hf, V, Nb, Ta, Mo, W, Mn, Fe, Co, and Ni are present;
0.0-6.0 wt %, or 0.3-5.0 wt %, or 0.5-3.0 wt %, or 0.7-2.0 wt %, of at least one element selected from the group consisting of Sc, Y and lanthanoids;
0.0-2.5 wt %, or 0.2-2.0 wt %, or 0.4-1.5 wt %, or 0.6-1.0 wt %, of at least one element selected from the group consisting of B, Ga, In, C, Si, Ge, Sn, and Pb;
and as a balance Al and unavoidable impurities, where percentages by weight add up to 100 wt % in the Cr-containing Al alloy.

2. The Cr-containing Al alloy of claim 1, wherein at least Mn and/or Zr is present.

3. The Cr-containing Al alloy of claim 1, wherein a microstructure of the Cr-containing Al alloy has been optimized by a thermal aftertreatment, wherein the Cr-containing Al alloy has a compression yield point of >300 MPa, or >350 MPa, or >400 MPa, or >450 MPa, and or a compression set of >8%, or >10%.

4. A process for producing a component from a Cr-containing Al alloy, comprising:
forming a Cr-containing Al alloy consisting of:
0.5-20.0 wt %, or 1.0-10.0 wt %, or 2.0-8.0 wt %, or 4.0-6.0 wt %, of Cr;
0.0-6.0 wt %, or 0.3-5.0 wt %, or 0.8-3.0 wt %, or 1.0-2.0 wt %, of at least one element selected from the group consisting of Ti, Zr, Hf, V, Nb, Ta, Mo, W, Mn, Fe, Co and Ni, where up to 3 elements selected from the group consisting of Ti, Zr, Hf, V, Nb, Ta, Mo, W, Mn, Fe, Co, and Ni are present;
0.0-6.0 wt %, or 0.3-5.0 wt %, or 0.5-3.0 wt %, or 0.7-2.0 wt %, of at least one element selected from the group consisting of Sc, Y and lanthanoids;
0.0-2.5 wt %, or 0.2-2.0 wt %, or 0.4-1.5 wt %, or 0.6-1.0 wt %, of at least one element selected from the group consisting of B, Ga, In, C, Si, Ge, Sn, and Pb;
and as a balance Al and unavoidable impurities, where percentages by weight add up to 100 wt % in the Cr-containing Al alloy, and
forming the component.

5. The process of claim 4, wherein the forming of the Cr-containing Al alloy comprises:
providing and mixing powders of the elements present in the Cr-containing Al alloy in weights required for the Cr-containing Al alloy, and
at least partly melting the powders.

6. The process of claim 5, wherein the melting is effected by at least one laser, wherein the component is produced by laser powder bed melting (LPB-M).

7. The process of any of claim 4, wherein a microstructure of the component is improved by a further heat treatment during the forming of the component.

8. The process of claim 4, wherein a pressure of 260-6700 bar, or 500-5000 bar, or 1000-2000 bar, is employed in the forming of the component, wherein the pressure is applied by at least one gas and or at least one liquid.

9. The process of claim 4, wherein external pressure is applied locally in the forming of the component.

10. A component formed according to claim 4.

11. A component comprising a Cr-containing Al alloy, consisting of:
0.5-20.0 wt %, or 1.0-10.0 wt %, or 2.0-8.0 wt %, or 4.0-6.0 wt %, of Cr;
0.0-6.0 wt %, or 0.3-5.0 wt %, or 0.8-3.0 wt %, or 1.0-2.0 wt %, of at least one element selected from the group consisting of Ti, Zr, Hf, V, Nb, Ta, Mo, W, Mn, Fe, Co and Ni, where up to 3 elements selected from the group consisting of Ti, Zr, Hf, V, Nb, Ta, Mo, W, Mn, Fe, Co, and Ni are present;
0.0-6.0 wt %, or 0.3-5.0 wt %, or 0.5-3.0 wt %, or 0.7-2.0 wt %, of at least one element selected from the group consisting of Sc, Y and lanthanoids;
0.0-2.5 wt %, or 0.2-2.0 wt %, or 0.4-1.5 wt %, or 0.6-1.0 wt %, of at least one element selected from the group consisting of B, Ga, In, C, Si, Ge, Sn, and Pb;
and as a balance Al and unavoidable impurities, where percentages by weight add up to 100 wt % in the Cr-containing Al alloy.

12. The component of claim 10, wherein the component is a component of a vehicle, or an aircraft or spacecraft, or a part thereof.

13. A vehicle, aircraft or spacecraft, comprising a component of claim 10.

14. A process for producing a Cr-containing Al alloy, consisting of:
0.5-20.0 wt %, or 1.0-10.0 wt %, or 2.0-8.0 wt %, or 4.0-6.0 wt %, of Cr;
0.0-6.0 wt %, or 0.3-5.0 wt %, or 0.8-3.0 wt %, or 1.0-2.0 wt %, of at least one element selected from the group consisting of Ti, Zr, Hf, V, Nb, Ta, Mo, W, Mn, Fe, Co and Ni, where up to 3 elements selected from the group consisting of Ti, Zr, Hf, V, Nb, Ta, Mo, W, Mn, Fe, Co, and Ni are present;
0.0-6.0 wt %, or 0.3-5.0 wt %, or 0.5-3.0 wt %, or 0.7-2.0 wt %, of at least one element selected from the group consisting of Sc, Y and lanthanoids;
0.0-2.5 wt %, or 0.2-2.0 wt %, or 0.4-1.5 wt %, or 0.6-1.0 wt %, of at least one element selected from the group consisting of B, Ga, In, C, Si, Ge, Sn, and Pb;
and as a balance Al and unavoidable impurities, where percentages by weight add up to 100 wt % in the Cr-containing Al alloy, comprising:
providing and mixing the elements present in the Cr-containing Al alloy in weights required for the Cr-containing Al alloy;
melting the elements; and
forming the Cr-containing Al alloy.

15. A process for producing a component, especially shaped article, comprising:
forming a Cr-containing Al alloy consisting of:
0.5-20.0 wt %, or 1.0-10.0 wt %, or 2.0-8.0 wt %, or 4.0-6.0 wt %, of Cr;
0.0-6.0 wt %, or 0.3-5.0 wt %, or 0.8-3.0 wt %, or 1.0-2.0 wt %, of at least one element selected from the group consisting of Ti, Zr, Hf, V, Nb, Ta, Mo, W, Mn, Fe, Co and Ni, where up to 3 elements selected from the group consisting of Ti, Zr, Hf, V, Nb, Ta, Mo, W, Mn, Fe, Co, and Ni are present;
0.0-6.0 wt %, or 0.3-5.0 wt %, or 0.5-3.0 wt %, or 0.7-2.0 wt %, of at least one element selected from the group consisting of Sc, Y and lanthanoids;
0.0-2.5 wt %, or 0.2-2.0 wt %, or 0.4-1.5 wt %, or 0.6-1.0 wt %, of at least one element selected from the group consisting of B, Ga, In, C, Si, Ge, Sn, and Pb;
and as a balance Al and unavoidable impurities, where percentages by weight add up to 100 wt % in the Cr-containing Al alloy, and
forming the component, shaped article, comprising a Cr-containing Al alloy.
